(19) United States
(12) Patent Application Publication
(10) Pub. No.: US 2017/0240141 A1
(43) Pub. Date: Aug. 24, 2017

(54) VEHICLE INTERIOR WINDOW CLEANING APPARATUS

(71) Applicant: Benjamin A. Fortner, Charlotte, NC (US)

(72) Inventor: Benjamin A. Fortner, Charlotte, NC (US)

(21) Appl. No.: 15/426,147

(22) Filed: Feb. 7, 2017

Related U.S. Application Data
(60) Provisional application No. 62/297,158, filed on Feb. 19, 2016.

(51) Int. Cl. B60S 3/00; B08B 1/00

(52) U.S. Cl. CPC B60S 3/008; B08B 1/006

(57) ABSTRACT

An apparatus for cleaning flat, curved, and/or concave vehicular interior windshields and windows which has a cleaning pad coupled with an attachable/removable cleaning moistened tissue integral with an extended handle which contains a vibrating source powered by dry cell batteries thru an off/on switch.

### RELATED APPLICATION

This application claims the benefit of co-pending U.S. provisional application Ser. No. 62/297,158 filed Feb. 19, 2016.

### FIELD OF THE INVENTION

The invention relates to an internally powered glass cleaning apparatus. More specifically to the interior surfaces of windshields and windows of vehicles.

### BACKGROUND

U.S. Pat. No. 5,890,249 to Hoffman discloses a household cleaning device that utilizes vibrating motion for cleaning action. However, the device does not have a solid transmitting medium from the vibration source to the application point. First is introduced a pivotally connecting joint that due to manufacturing tolerances and fit negates and disrupts a percentage of the vibrating frequency. Second the cleaning head has on both sides flexible foam like material that negates, absorbs and does not transmit vibrational frequency. Third the brush bristles are flexible and therefore a poor transmitter of vibrating energy. It may be concluded that the vibration generator has little effect on the cleaning action of the device due to no completely solid transmitting medium from source to application. Additionally, the device is directed exclusively to household cleaning with no mention of cleaning automotive interior windshields; therefore, the cleaning head is so thick that it would prevent cleaning the acute angle at the windshield/dash board intersection. The spring clip hardware could also inflect damage to many contacted surfaces. This patent has expired.

A/C, heat or defroster venting air flow is directed at the inside of the windshield and windows and the particulate grime that this flow conveys mixes with the moisture on the windshield and windows to produce haze, streaking, and obscured vision. This window residue is particulates due to condensation usually hydrocarbons from fuel and oil in traffic, brake dust, tire wear residue, dirt, and cigarette smoke. Also, a hot car in summer produces out-gassing of plastics, leather and rubber as part of this particulate grime on interior windshields and windows.

The automotive windshield was invented in the early 1900's and has evolved to the configurations that we have today. Extremely aerodynamic, curved and concave with acute angles intersecting and mating with the vehicle body, The front and back windows are today actual structural components in the automotive design. The side windows are also curved yet functional. This curvature, acute angles, deep dash and expanse of glass create unique cleaning problems.

Interior windshield and window cleaning is nominally accomplished by hand. Various cleaning pads, mitts, solutions and tools have been marketed to accomplish this cleaning. However, all of these require physical dexterity, physical strength and aggressive scrubbing by hand to rub the surfaces clean.

### SUMMARY OF THE INVENTION

With the forgoing in mind the vehicle interior windows cleaning apparatus solves all these problems by providing as integral molded plastic assembly consisting of a pad and handle with the provision for incorporating a pre-moistened cleaning tissue which when coupled with internal aggressive vibrating motion provided a window cleaning mechanism when the pad is held in contact with the vehicular interior windows, thus completely eliminating the-need-for physical strength and aggressive-scrubbing by hand.

The pad is molded as a thin flat sheet with an inherent ability to provide a slight degree of flex when coupled with a series of slots that provide hinge points at the termination point of each adjacent slot thus creating an integral independent hinged tab which adjusts to the curvature/concaveness of the interior surface of vehicular windows when applied for cleaning. Additionally, the tabs provide transitional independent surface contacts when the tab is moved across flat to curved to concave glass surfaces. Also, the slots create a grid that provides additional contact edges between the cleaning tissue and the surface to be cleaned thru the contact friction of the slot edge.

Three tissue anchor points are molded into the upper surface of the pad. These anchor points are molded in a thinner thickness than the pad thickness, thus providing a greater degree of flexure which coupled with the central intersecting of the radiating anchor point slots provide sharp points that capture and hold the cleaning tissue that is folded over the pad edges and then inserted into the anchor points by finger pressure.

The operational sequence of the vehicle interior cleaning apparatus is as follows:
1. Attach a cleaning tissue to the pad utilizing the anchor points.
2. Activate the vibrating motion of the apparatus.
3. By simple hand motion place the pad in contact with the surface to be cleaned.
4. Utilize a horizontal motion followed by a vertical motion to accomplish a mechanized vibration cleaning.
5. As the tissue becomes dirty or dries-out, it can be replaced as necessary.

### BRIEF DESCRIPTION OF THE DRAWINGS

FIGS. 1, 2, 3 and 4 are drawn to a reduced scale.

FIG. 1 is a top view of a preferred embodiment of the invention, which consists of a handle integral with a pad.

FIG. 2 is a side view of a preferred embodiment of the invention depicting the apparatus acute angle configuration which is necessary to access the vehicle interior windshield acute angle intersection with the dashboard.

FIG. 3 is a bottom view of a preferred embodiment depicting the pad slots and cleaning tissue anchor points.

FIG. 4 is a top view of the pad, less the handle and slots for clarity, showing the cleaning tissue ready for attachment to the pad.

### DESCRIPTION OF THE INVENTION

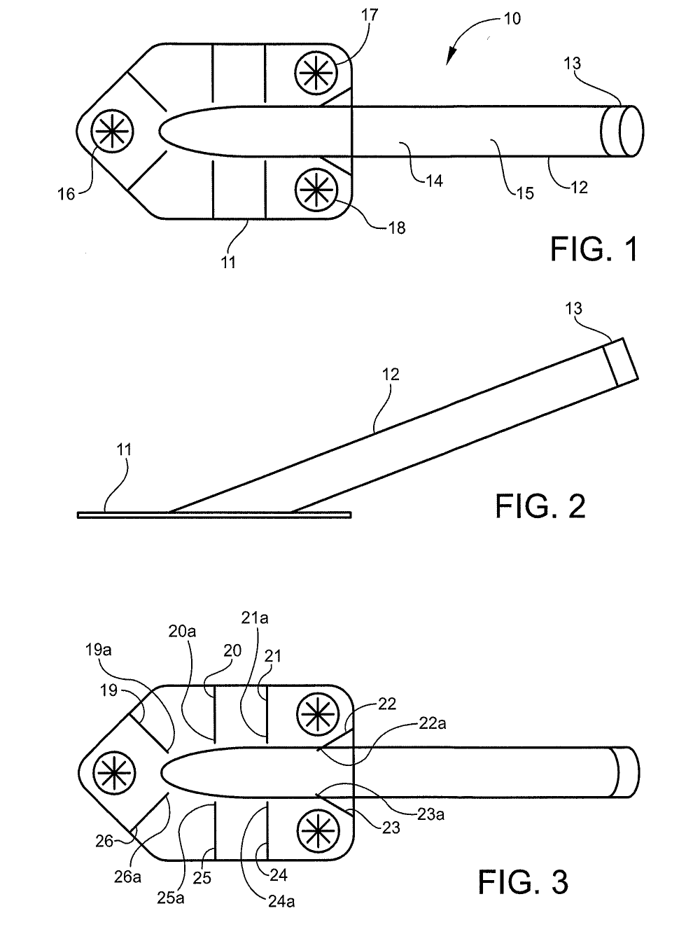

FIGS. 1, 2, and 3 illustrate one embodiment of the apparatus 10 according to the invention which include the pad 11, the handle 12, the off/on switch 13, the vibrating DC motor 14, the DC batteries 15, three anchor points 16, 17 and 18, eight slots 19, 20, 21, 22, 23, 24, 25 and 26, and eight hinge points 19a, 20a, 21a, 22a, 23a, 24a, 25a and 26a. Additionally the FIGS. 1, 2 and 3 illustrate one embodiment of the apparatus 10 according to the invention which include the pad 11, the handle 12, the off/on switch 13, the vibrating DC motor 14, the DC batteries 15, three-anchor points 16, 17, and 18, eight slots 19, 20, 21, 22, 23, 24, 25 and 26, and eight hinge points 19a, 20a, 21a, 22a, 23a, 24a, 25a and 26a. Additionally the pad 11 surface area between adjacent slots 19 and 20 with an imaginary hinge line between hinge points 19a and 20a, for an example of all eight hinge lines, is defined as a tab. FIG. 2 also depicts the handle 12 and pad 11 approximate acute angular relationship.

The invention may also be described as: A hand held continuous integral physical apparatus that can transmit vibrational frequencies throughout the entire apparatus without attenuation or interruption of the frequencies. A small flat sheet, integral physically with a cylindrical tubular handle thereby creating an apparatus that the small flat sheet can flex to provide surface contact when applied to a curved surface. A small flat sheet integral physically with a cylindrical tubular handle with a series of slots approximately perpendicular to the flat sheet edges that extend part-way toward the center of the small flat sheet thus creating a tab between each adjacent slot thereby creating an apparatus that the small flat sheet with the tabs created by adjacent slots can flex independently of each other and provide surface contact when applied to a curved and/or concave surface. The apparatus may also include, utilize, and dispose a cleaning tissue that is attached to the pad by integral anchor points. The activated and functional capabilities of the apparatus are utilized to clean flat, curved and concave interior vehicular windshields and window surfaces.

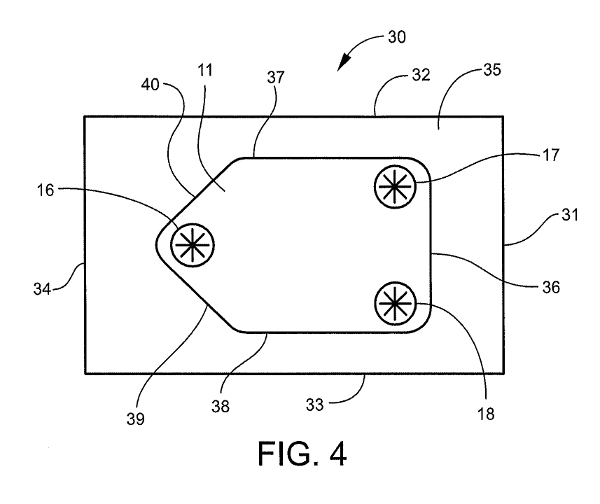

FIG. 4 is the assembly 30 of the cleaning tissue 35 with the pad 11. To complete the assembly/attachment of the cleaning tissue 35 to the pad 11 tissue edge 31 is folded over edge 36 and the tissue is inserted into anchor points 17 and 18; edge 32 is folded over edge 37 and inserted in anchor point 17; edge 33 is folded over edge 38 and inserted in anchor point 18; and edge 34 is progressively folded over edge 39 and edge 40 and inserted in anchor point 16. All insertions are finger pressure.

The vehicular interior surfaces of windshields and windows can now be cleaned by an effective apparatus in a simple and easy manner.

I claim:

1. A handheld device for cleaning the interior surface of a vehicle window comprises:
a handle containing a vibratory motor, the handle has two ends,
a pad joined with one end of the handle at an acute angle therebetween, the pad is generally rectangular with a pointed end, the pad has at least one tab formed by slots in the pad, so that the tab flexes to conform to the interior surface during cleaning, the pad has at least one anchor point, and
a tissue for cleaning, the tissue is removably affixed to the pad via the anchor point.
